(19) United States
(12) Patent Application Publication
(10) Pub. No.: US 2017/0106530 A1
(43) Pub. Date: Apr. 20, 2017

(54) ADMINISTRATION SERVER, ADMINISTRATION SYSTEM, AND ADMINISTRATION METHOD

(71) Applicant: HITACHI, LTD., Tokyo (JP)

(72) Inventors: lsao SHIMOKAWA, Tokyo (JP); Seishi HANAOKA, Tokyo (JP)

(21) Appl. No.: 15/281,267

(22) Filed: Sep. 30, 2016

(30) Foreign Application Priority Data
Oct. 16, 2015 (JP) 2015-204723

(51) Int. Cl. B25J 9/00; B25J 9/16; G05B 19/042

(52) U.S. Cl. CPC B25J 9/0084; G05B 19/0428; B25J 9/1694; B25J 9/161; G05B 2219/39059

(57) ABSTRACT

In a case where an administration server is disposed, and manages and operates a plurality of robots, a robot operation may be impaired due to a request interval for extracting sensor information stored in a robot from the robot, the types of sensors, and the number of sensors.

### INCORPORATION BY REFERENCE

The present application claims priority from Japanese patent application JP 2015-204723 filed on Oct. 16, 2015, the entire contents of which are hereby incorporated by reference into this application.

### BACKGROUND

The present embodiment relates to an administration server, an administration system, and an administration method, and particularly to an administration server, an administration system, and an administration method, capable of managing a plurality of apparatuses and monitoring and controlling the apparatuses.

In recent years, the Internet of things (IoT) has attracted attention, the IoT connecting all apparatuses to the Internet so as to achieve monitoring and control of various apparatuses. An IoT apparatus is connected to the Internet so as to share information of other apparatuses, and provides a new added value which cannot be provided by an individual apparatus. The IoT is expected as the next generation network model creating new businesses.

An example of the IoT apparatus may include a network robot (hereinafter, referred to as a robot). The robot is connected to a network, and thus various information can be retrieved from the robot and the robot can be controlled from a remote location via the Internet. According to the News release from Ministry of Economy, Trade and Industry, 2013 (http://www.meti.go.jp/press/2013/02/20140217002/20140217 002.html), there have been strong expectations for the use of the robot technology in the field of lifestyle supports and the like such as nursing care for the elderly due to the present progress of aging. On the other hand, since a lifestyle support robot frequently contacts with humans, for full-fledged introduction of the lifestyle support robot, it is necessary to improve techniques, standards, and rules for human safety and to provide a system to prove safety measures. Also from the News release, techniques for human safety are necessary, and, in a case where the human safety is taken into consideration, it is necessary to perform rapid control so as to avoid collision with a human when a robot performs an action such as “walking”, and it is also necessary to normally monitor a surrounding situation. Thus, an IoT apparatus such as a robot requires highly frequent information collection and feedback to control highly frequently unlike an IoT apparatus which is typified by a smart meter.

Regarding a method of remotely monitoring and controlling operation states of hardware and software of an apparatus in real time, JP-A-2012-198796 discloses a log collection system in which, “in order to reduce time and effort to collect, manage, and set log information of a terminal device when remotely monitoring an operation state of the device in real time” (Abstract), “log collection means of a server device is instructed to change settings of the content, granularity, and a collection frequency of log information collected from a terminal apparatus based on the type of log information which is listed up due to deficiency of information indicating event candidates expected as causes of the occurrence of abnormalities and analysis thereof” (paragraph [0057]).

JP-A-2008-226222 discloses “a control system having good communication efficiency and a signal transmission method” (paragraph [0005]), the control system “including a unit controller receiving a plurality of sensor signals from a plurality of sensors, and transmitting the plurality of sensor signals to a host controller by using a transmission frame transmitted in a predetermined transmission period via a serial line, and the host controller receiving the plurality of sensor signals and transmitting an operation control signal to the unit controller” (claim 15).

### SUMMARY

As described above, an IoT apparatus such as a robot requires highly frequent information collection or feedback to control unlike an IoT apparatus whose representative is a smart meter, and thus communication frequencies on the IoT apparatus side and a server side are high. Generally, an IoT apparatus is not mounted with a high performance CPU or the like in order to be provided at low cost, and highly frequent communication processes impose a load on the CPU. Thus, particularly, an IoT apparatus having a movable portion, such as a robot may influence processes other than communication, for example, an operation of the apparatus. Particularly, in a case of a robot whose operation is controlled by an IoT apparatus while monitoring a surrounding situation at all times, the IoT apparatus always transmits sensor information to an administration server, and receives a control command for the robot based on processing in the administration server. Therefore, a case is expected in which there is a high probability that an operation of the apparatus may be influenced.

In JP-A-2012-198796, the server device lists up deficient information in order to analyze an abnormal state, but, in a case where there is a large amount of deficient information when an abnormal state is analyzed, it is necessary to acquire a large amount of information from the terminal device, and thus CPU resources of the terminal may be uselessly wasted. In this case, if the terminal device handles an urgent event, for example, if an operation of transmitting an urgent mail is performed, a case is expected in which a malfunction occurs in interruption of the CPU, and thus there is the occurrence of such a failure that the mail cannot be transmitted. A case is expected in which there is a high probability that communication disconnection occurs in communication between the terminal and the server. On the contrary, if resource management is performed, and an amount of acquired information is reduced by taking into consideration a CPU resource, a failure cause may not be investigated. This is because information required to analyze an abnormal state and a CPU resource of the terminal have a trade-off relationship, and correlation between granularity of deficient information or sensor information and the resource of the terminal device is not clear. A case is expected in which this does not necessarily achieve high quality resource management, and highly frequent collecting of sensor information stored in a RAM of the robot influences an operation of the robot.

In JP-A-2008-226222, a case is expected in which there is a probability that changing of a sampling period in the unit controller may influence each resource (a CPU or a memory), and thus the unit controller causes operation errors. This is because correlation between the sampling cycle and the resource of the unit controller is not clear. A case is expected in which this causes operation errors in the unit controller if a sampling cycle is high.

In a case where the techniques disclosed in the above two publications are applied to a system in which an administration server remotely controls and operates a plurality of robots, a large amount of sensor information stored in RAMs of the robots is extracted from the robots without accurately setting a request interval and the types of sensors. Thus, a CPU use ratio increases unlimitedly, and therefore it is expected that a malfunction occurs in interruption or the like of CPUs of the robots, and thus there is a high probability that control of the robots may be brought into an unstable state. It is expected that communication between the administration server and the robots may be disconnected due to the high CPU use ratio of the robots. In this case, RAS indicating reliability, availability, and serviceability in a robot system is low.

In order to prevent such a failure, especially, changing of a behavior status of the robot is violent, and thus it is necessary to perform resource management of tracking a request interval for acquiring sensor information from the robot with high accuracy and changing the request interval with respect to the changing of a behavior status. In the present specification, behavior states of a robot such as “walking”, “sitting”, and “standing” are defined as “behavior statuses”. These behavior statuses are periodically stored in a RAM of the robot as parameters.

In light of the above description, a technique or a method is disclosed for preventing the occurrence of a state in which robot control becomes unstable or in which communication is disconnected.

According to the first example, there is provided an administration server comprising:

an action definition file in which the number of sensors, types of sensors, and a CPU threshold value are stored in advance with respect to a behavior state of an apparatus having a plurality of sensors; and

a processing unit,

wherein the processing unit
acquires a behavior state of the apparatus,
refers to the action definition file, and determines the number and types of a plurality of sensors which acquire data from the apparatus, based on the number of sensors and the types of sensors for the behavior state of the apparatus, and
determines a request interval for requesting a data acquisition of the plurality of sensors so that a CPU use ratio of the apparatus does not exceed the CPU threshold value by the number of sensors.

According to the second example, there is provided an administration system comprising:

an apparatus having a plurality of sensors; and

an administration server having an action definition file in which the number of sensors, types of sensors, and a CPU threshold value are stored in advance with respect to a behavior state of the apparatus;

wherein the administration server
acquires a behavior state of the apparatus,
refers to the action definition file, and determines the number and types of a plurality of sensors which acquire data from the apparatus, based on the number of sensors and the types of sensors for the behavior state of the apparatus,
determines a request interval for requesting data acquisition of the plurality of sensors so that a CPU use ratio of the apparatus does not exceed the CPU threshold value by the number of sensors,
requests the data acquisition of the plurality of sensors to the apparatus in accordance with the request interval, and

wherein the apparatus transmits the data of the plurality of sensors to the administration server in response to the request from the server.

According to the third example, there is provided an administration method by an administration server, the administration server comprising:

an action definition file in which the number of sensors, types of sensors, and a CPU threshold value are stored in advance with respect to a behavior state of an apparatus having a plurality of sensors; and

a processing unit,

wherein the processing unit
acquires a behavior state of the apparatus,
refers to the action definition file, and determines the number and types of a plurality of sensors which acquire data from the apparatus, based on the number of sensors and the types of sensors for the behavior state of the apparatus, and
determines a request interval for requesting a data acquisition of the plurality of sensors so that a CPU use ratio of the apparatus does not exceed the CPU threshold value by the number of sensors.

According to the teaching herein, it is possible to prevent the occurrence of a state in which robot control becomes unstable or communication is disconnected by controlling a request interval from an administration server to a robot.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system summary diagram of the present embodiment.

FIG. 2 is a hardware configuration diagram of an administration server in the present embodiment.

FIG. 3 is a simple hardware configuration diagram of a robot which is an IoT apparatus in the present embodiment.

FIG. 4 is an explanatory diagram of an action definition file (1) showing a table defining the types and the number of sensors, and a CPU threshold value for each behavior status of a robot in the present embodiment.

FIG. 5 is an explanatory diagram of an action definition file (2) showing a table in which the types and the number of sensors, and a CPU threshold value for each set of a behavior status and radio wave intensity of a robot in the present embodiment.

FIG. 6 shows a graph for explaining a relationship among the types of sensors, the number of sensors, and a request interval in the present embodiment.

FIG. 7 is a diagram for explaining control for dynamically changing a CPU load ratio and a request interval for each status of a robot in the present embodiment.

FIG. 8 is a flowchart for explaining a method in which CPU threshold values, the number of sensors, and the types of sensors are defined according to a behavior status of a robot in a case where the administration server acquires sensor information stored in a RAM of the robot from the robot, and control is performed so that a CPU use ratio is equal to or less than the set CPU threshold value, in the present embodiment.

FIG. 9 is a diagram for explaining a system operation summary in the present embodiment.

FIG. 10 is a diagram for explaining that the types of sensors are dynamically changed and controlled in a case where the number of sensors is five in the present embodiment.

FIG. 11 is a diagram for explaining a request interval table defining a request interval for each sensor in a case where the number of sensors to be acquired is ten in the present embodiment.

FIG. 12 is a diagram for explaining a request interval table which is obtained in such a manner that the administration server clusters plural pieces of sensor information stored in the RAM of the robot from the robot, and defines a request cycle for each cluster in the present embodiment.

FIG. 13 is a diagram for explaining a request interval table which is obtained in such a manner that the administration server clusters plural pieces of sensor information stored in the RAM of the robot from the robot, and defines a request cycle for each cluster, further defines the priority for each cluster in the present embodiment.

FIG. 14 is a diagram for explaining a request interval table which is obtained in such a manner that the administration server clusters plural pieces of sensor information stored in the RAM of the robot from the robot, and defines a request cycle for each cluster, further defines the priority for each cluster, further defines a data change ratio of acquired sensor information in the present embodiment.

FIG. 15 is a diagram for explaining a request interval table which is obtained in such a manner that the administration server clusters plural pieces of sensor information stored in the RAM of the robot from the robot, and defines a request cycle for each cluster, further defines the priority for each cluster, further defines a data change ratio of acquired sensor information for each cluster and defines an average value for each cluster in the present embodiment.

FIG. 16 is a diagram for explaining a request interval table which is obtained in such a manner that the administration server clusters plural pieces of sensor information stored in the RAM of the robot from the robot, and defines a request cycle for each cluster, further defines the priority for each cluster, further defines a data change ratio of acquired sensor information, and still further defines whether or not sensor information is aggregated when the robot transmits the sensor information in the present embodiment.

FIG. 17 is a diagram for explaining a request interval table which is obtained in such a manner that the administration server clusters plural pieces of sensor information stored in the RAM of the robot from the robot, and defines a request cycle for each cluster, further defines the priority for each cluster, further defines a data change ratio of acquired sensor information, even further defines a cluster having the highest correlation through computation of a correlation coefficient among clusters based on time-series data of each piece of sensor information distributed to the clusters in the present embodiment.

FIG. 18 is a diagram for explaining a request interval table which is obtained in such a manner that the administration server clusters plural pieces of sensor information stored in the RAM of the robot from the robot, and defines a request cycle for each cluster, further defines the priority for each cluster, further defines a data change ratio of acquired sensor information, even further defines a Mahalanobis distance for each cluster based on time-series data of acquired sensor information in the present embodiment.

### DETAILED DESCRIPTION OF THE EMBODIMENTS

### A. Summary

An administration system according to the present embodiment is, for example, a system in which an apparatus including a sensor and a server perform communication in a wireless or wired manner, in which the server periodically detects a behavior state of the apparatus, determines the number and types of sensors data of which is to be acquired therefrom according to the behavior state of the apparatus, and determines a cycle (request interval) for acquiring the data from the sensors so that a CPU use ratio of the apparatus does not exceed a predetermined threshold value, and in which the apparatus transmits sensor information to an administration server based on requested sensor information or apparatus setting information which is periodically transmitted from the server.

### B. System and Device

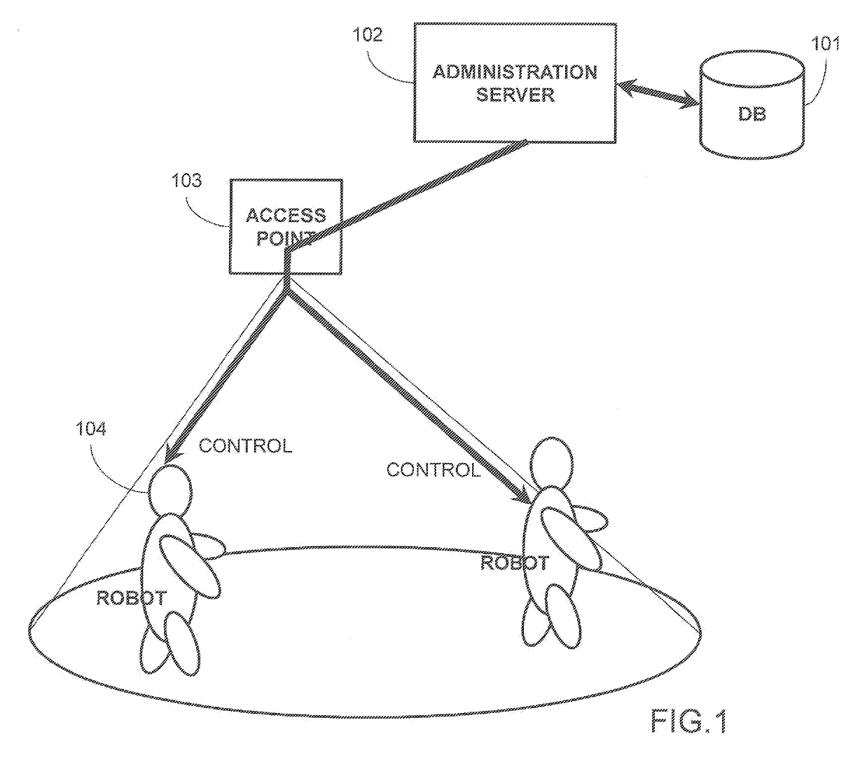

FIG. 1 is a system diagram of a first embodiment. FIG. 1 is a diagram illustrating an administration system in which an administration server controls and manages a plurality of robots. The system includes an administration server 102, an access point (an access point such as a wireless LAN base station) 103, robots 104, and a database (DB) 101. In this system, the administration server 102 acquires sensor information stored in a RAM of each of the robots 104 from the robot 104, and controls each robot 104. The robot 104 includes a CPU and a communication interface in a head thereof, and controls joints of the robot 104 and various actuators provided in a body thereof in order to control the body, arms, feet, or the like thereof. An OS such as a robot operation system (ROS) controls communication or the like with an external apparatus via the communication interface by using the CPU. The administration server 102 transmits a request for sensor information acquisition to the robot 104 in order to acquire sensor information stored in the robot 104, and each robot 104 having received the request transmits the sensor information stored in the RAM to the administration server 102 via the wireless LAN base station by using wireless communication. A communication protocol used in this case may be, for example, Transmission Control Protocol (TCP) or Simple Object Access Protocol (SOAP). The administration server 102 having receiving the sensor information stores the sensor information in a RAM and a database thereof. As mentioned above, the plurality of robots 104 are managed and are controlled with high accuracy by the administration server 102, and thus it is possible to apply the robots 104 to various services. The administration server 102 may provide control software to a robot administrator at a remote location via a cloud such as SaaS. Since highly accurate control is necessary when the administration server 102 controls the robots 104, it is essential to perform a control method such as a closed loop control method in which various sensor information are extracted from the robot 104, and control is performed based on the information. In a case where the administration server 102 acquires sensor information required in control from the robot 104 via the access point 103, if the administration server 102 requests the robot 104 to transmit a large amount of sensor information stored in the RAM of the robot 104 in order to perform highly accurate control, the CPU of the robot 104 is frequently used to respond to the request. Therefore, it is expected that a CPU use ratio increases to cause a malfunction in interruption of the CPU, and thus control of the robot 104 may possibly be brought into an unstable state. In a case where the control of the robot is in an unstable state, human safety is neglected. Consequently, it is expected that the human safety may be neglected, for example, the robot 104 may collide with a human during walking thereof. In this case, in the robot system, RAS of the system is very low. As mentioned above, it is necessary to control a request interval for acquiring the sensor information stored in the RAM of the robot 104, to an extent to which robot control is not brought into an unstable state. The control software executed by the administration server 102 includes a monitoring screen, and a control screen for controlling the robots 104. The administration server 102 acquires sensor information stored in the RAM of the robot 104, and displays the acquired sensor information on the monitoring screen in real time. Images may be periodically acquired from a camera of the robot 104 so as to be displayed as moving images on the monitoring screen. An administrator may control the robots 104 from a remote location according to various situations while viewing the monitoring screen.

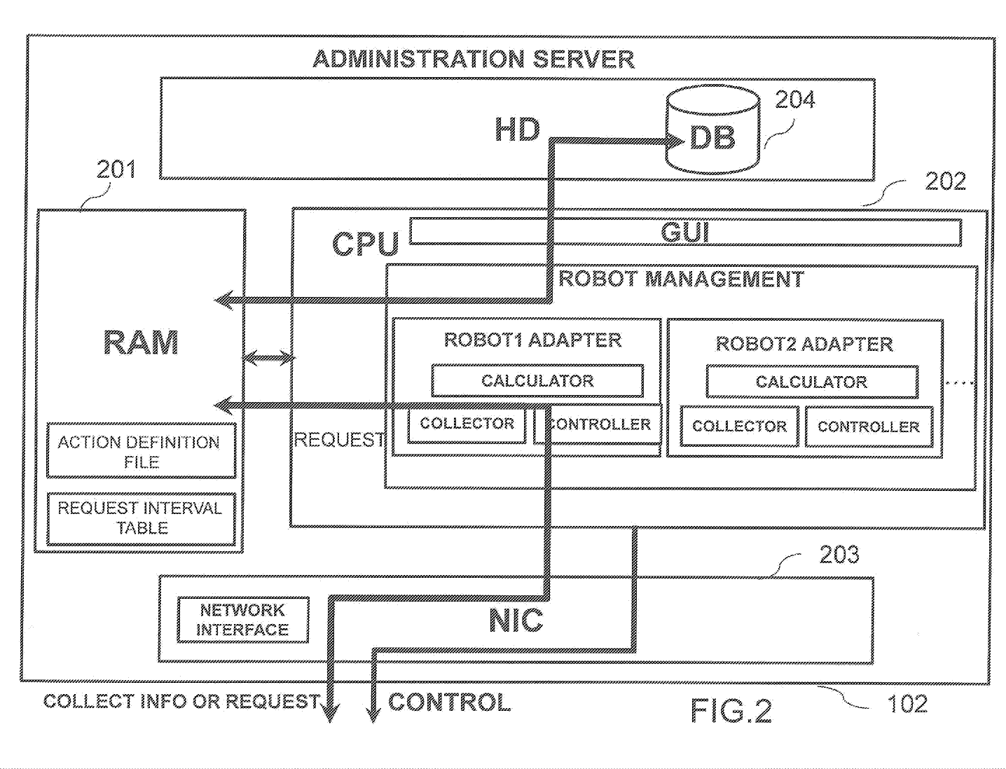

FIG. 2 is a hardware configuration diagram of the administration server in the present embodiment. The administration server includes a RAM 201, a CPU 202, a network interface card (NIC) 203, and a DB 204 as hardware. Control software driven in the administration server is stored in the RAM, and is executed via the CPU. Communication with the robot is performed via the NIC 203. The administration server may store sensor information stored in the RAM, in the DB of a hard disk, and may store the sensor information in an external hard disk. The administration server has, as functional blocks, a GUI, a robot adapter, a robot management unit, and a network interface. The robot management unit receives sensor information transmitted from a plurality of robots, stores the sensor information in the database or the RAM, and controls the plurality of robots. The robot management unit includes a plurality of robot adapters which receive sensor information from respective robots and control the robots. As mentioned above, the robot management unit includes the plurality of robot adapters which receive sensor information from the respective robots and control the robots, and can thus simultaneously control the plurality of robots. The robot adapter includes a collector which receives sensor information from the robot, a controller which controls the robot, and a calculator which performs conversion into information which is required for the controller to perform control based on acquired sensor information, or performs computation, and transmits a computation result to the controller. The controller performs robot control based on information transmitted from the calculator. The calculator clarifies correlation between a CPU resource which is computed in advance and the apparatus, and then instructs the collector to set a request interval to be equal to or less than a CPU threshold value. The robot management unit transmits various sensor information transmitted from the respective robots, to the GUI in response to a request therefrom as data.

The RAM 201 stores an action definition file, a request interval table, and the like (which will be described later in detail).

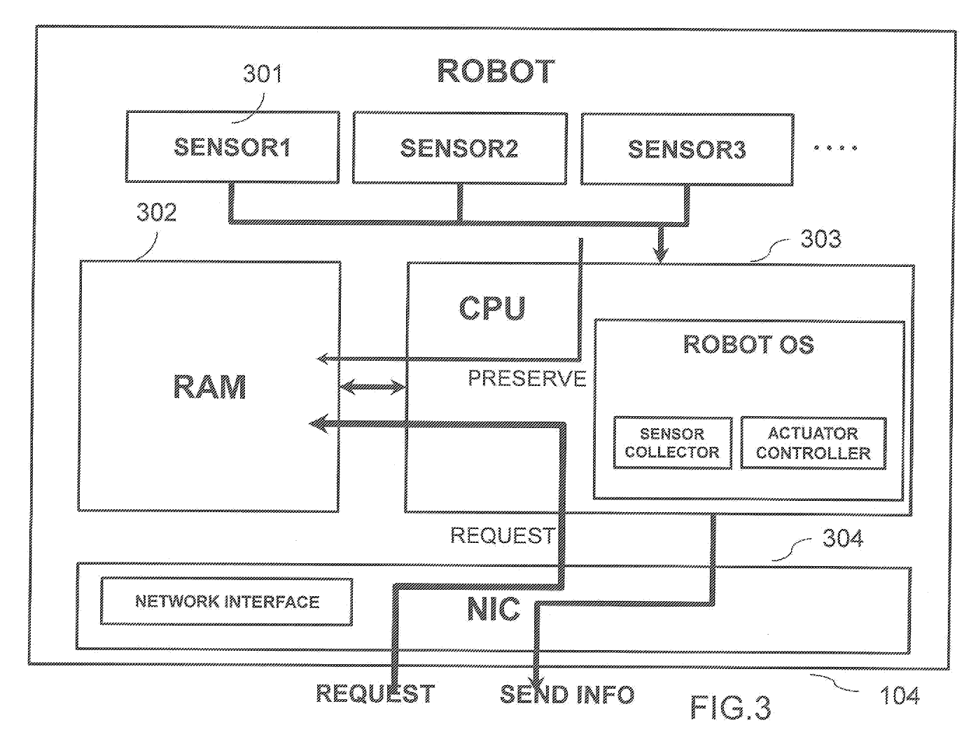

FIG. 3 is a hardware configuration diagram of the robot which is an IoT apparatus in the present embodiment. The robot has a plurality of actuators, and a robot OS (ROS) or the like controls the various actuators by using the CPU. The robot has a plurality of sensors 301, and the ROS or the like controls the plurality of sensors, and always stores the sensor information in the RAM. In a case where sensor information is requested from the administration server via a network interface card (NIC) 304, the ROS or the like appropriately extracts the sensor information stored in the RAM, and transmits the sensor information to the administration server by using a communication protocol such as TCP or SOAP.

The robot includes a sensor collector, an actuator controller, and a network interface. The robot controls the actuators incorporated into respective joints of the robot by using the actuator controller so as to drive the robot. The sensor collector extracts sensor information from the various sensors and stores the sensor information in the RAM. As described above, the operation of storing the sensor information in the RAM is performed in the robot, and the ROS or the like performs scheduling control in order to store sensor information in the RAM efficiently, and thus a load on the CPU of the robot is considerably reduced. In a case where the administration server requests sensor information to be transmitted to the administration server, the sensor collector extracts sensor information which is instructed to be transmitted to the administration server, from the RAM, and transmits the sensor information to the administration server via the network interface by using a communication protocol such as TCP or SOAP. The sensor collector may send back sensor information requested from the administration server to the administration server according to whether or not the sensor information is aggregated and the priority of each sensor, requested from the administration server.

In this case, the operation of storing the sensor information in the RAM is performed in the robot, and the ROS or the like performs scheduling control in order to store sensor information in the RAM efficiently, and thus a load on the CPU of the robot is reduced. However, for an external request such as a request from the administration server to the robot for extracting sensor information from the RAM, the ROS or the like cannot control scheduling on such an external request and thus a load on the CPU of the robot increases. A case is expected in which a CPU load ratio of the robot increases under a situation in which an external request is frequently made. In this case, a CPU load ratio increases according to a frequently made request, and this may possibly bring robot control into an unstable state or cause communication disconnection between the administration server and the robot. Therefore, it is necessary to control an external request to an extent to which a failure does not occur, for example, robot control is not brought into an unstable state. In other words, the failure such as an unstable state of robot control occurs due to the increase in a CPU load ratio. Therefore, in the CPU resource of the robot, a predetermined threshold value is required to be determined in advance so that a failure such as communication disconnection from the administration server due to deficiency of the CPU resource or an unstable state of robot control does not occur, and thus it is necessary to drive the robot at a CPU use ratio which is equal to or less than the predetermined threshold value.

### C. Behavior Status, CPU Load, and Action Definition File

In describing the present embodiment in detail, a dependency is qualitatively considered with respect to a CPU load of the robot. The CPU load may greatly depend on the following three factors.

(1) Behavior status of robot
(2) Types of sensors and number of sensors
(3) Interval between requests sent from administration server to robot in order to collect information

First, regarding the above (1), a CPU load ratio greatly depends on a behavior status of the robot, and a CPU threshold value not causing an unstable state of robot control differs for each behavior status of the robot. The “behavior status” indicates, for example, behavior states of the robot such as “WALK (walking)”, “SIT (sitting)”, and “STAND (standing)” of the robot. The robot periodically stores these behavior statuses in the RAM as parameters, and thus the server can acquire the behavior statuses from the RAM. Since the influence exerted on the CPU differs for each behavior status of the robots, it is necessary to define a CPU threshold value for each behavior status. As an example, in a case where a behavior status of the robot is “SIT”, even if sensor information stored in the RAM of the robot is periodically extracted, and thus a CPU load ratio increases to about 50%, an operation of the robot is not influenced until the CPU load ratio becomes 50%. However, if sensor information is extracted in a case where a behavior status of the robot is a “WALK” state at a request interval in a case where a behavior status is a “SIT” state, a CPU load caused by the walking action is added to the CPU load ratio of 50%, for example, and thus the CPU load ratio increases to, for example, 60% or more. In this case, in a state in which the CPU load ratio exceeds 60%, communication disconnection or an unstable state of robot control may occur. Particularly, in a case where control becomes unstable during walking of the robot, human safety is neglected, and this may cause serious damage to a customer. However, in a case where a behavior status of the robot is a “SIT” state, even if communication disconnection or an unstable state of robot control occurs, it is expected that there is a low probability that the robot may do damage to a human or an object. As mentioned above, by taking into consideration human safety for each behavior status, it is essential to test and define whether or not quality of service (QoS) of the robot is maintained at what extent of a CPU load, with the robot in advance.

Next, regarding the above (2), the CPU load ratio greatly depends on the types of sensors and the number of sensors. For example, as sensors, there are temperatures of motors which move joints of the arms, the head, the feet, and the like of the robot, and images from the camera of the head of the robot, and influences of the temperatures and the images on the CPU are different from each other. The number of sensors for acquiring information greatly influences the CPU. For example, the robot has about 4000 pieces of sensor information, and loads on the CPU are different from each other in a case of periodically acquiring 10 pieces of sensor information and in a case of periodically acquiring 40 pieces of sensor information. Of course, the case of periodically acquiring 40 pieces of sensor information has greater influence on the CPU.

Regarding the above (3), a request interval for acquiring a sensor (sensor information) also greatly influences a CPU load. The influence on a CPU load differs for each request interval for acquiring sensor information. Of course, a case where a request interval is short has greater influence on a CPU load.

In other words, a CPU load greatly depends on (1) a behavior status, (2) the types of sensors and the number of sensors, and (3) a request interval. In a case where resource management is performed by taking into consideration the CPU of the robot in order to perform highly accurate control, it is very important to examine such a relationship carefully in advance.

To achieve a highly accurate robot operation by performing resource management based on the above description, it is necessary to define four parameters, that is, a CPU threshold value (for example, an upper limit value of an allowable CPU load or the like during operation), the types of sensors, the number of sensors, and a request interval for each behavior status.

The three parameters, that is, the types of sensors, the number of sensors, and the CPU threshold value have high priority parameters when determined for each behavior status, and are determined at the discretion of the administrator. This is because defining the types of sensors, the number of sensors, and the CPU threshold value for each behavior status depends on service content and QoS of the robot. In other words, what service is provided (a behavior status, the types of sensors, and the number of sensors), and to what extent the quality of the provided service (CPU threshold value) is are within the discretion of the administrator, and the types of sensors, the number of sensors, and the CPU threshold value are defined for each behavior status based on the provided service and the service quality. For example, in a case of a service in which the robot performs reception work instead of a human, a behavior status of the robot is always expected to be a “SIT” state, and, in this case, the robot contacts customers over a counter. Therefore, human safety is negligible, and, for example, even if the robot is required to be reactivated due to the occurrence of, for example, an unstable state of control or communication disconnection, and thus service quality is lowered, it can be expected that customers are not physically damaged. In this case, high quality service may be provided to customers by setting the CPU threshold value to be great, defining the types of sensors and the number of sensors to be multiple, and acquiring such information. In addition, availability of a robot may be ensured by setting the CPU threshold value to be small, and defining the types of sensors and the number of sensors so that an unstable state of robot control or communication disconnection does not occur. These are all defined at the discretion of an administrator or a service provider.

Here, a request interval is defined based on the CPU threshold value, the behavior status, the types of sensors, and the number of sensors, which are determined. This is because, since a CPU load greatly depends on a behavior status, the types of sensors, the number of sensors, and a request interval, a relational expression is derived through careful examination of a relationship thereamong in advance, and thus the request interval can be calculated. A request interval may be first defined based on such a relational expression, and then a behavior status, the types of sensors, and the number of sensors may be determined. However, when taking into consideration a robot service, a request interval may be generally lower than other parameters in terms of priority.

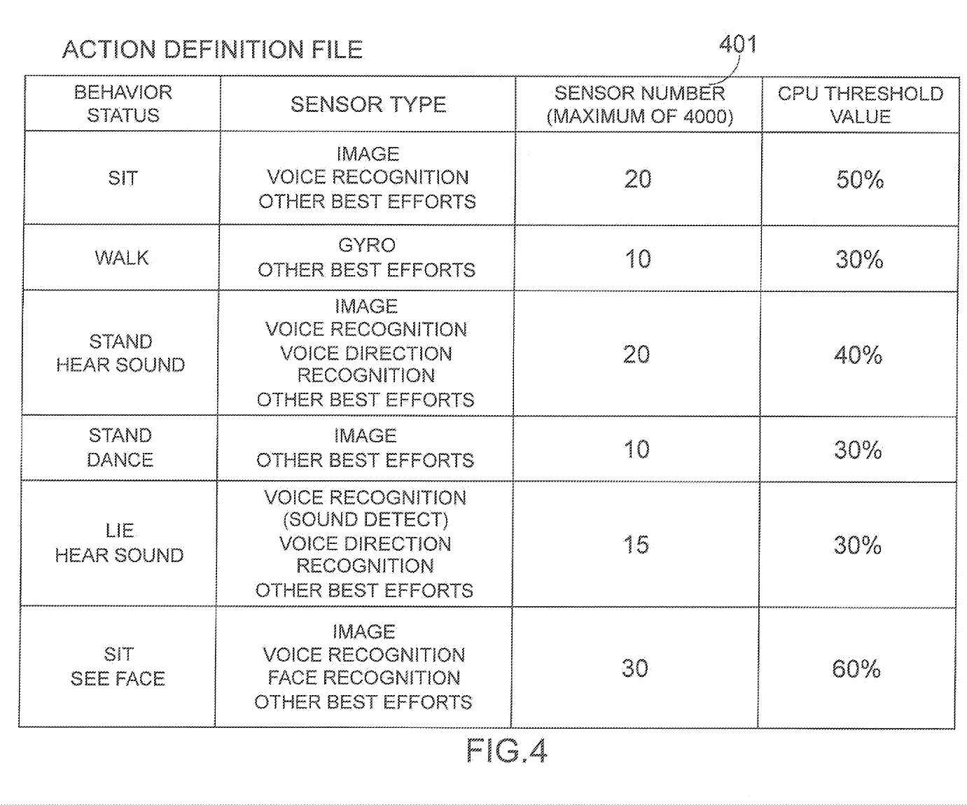

FIG. 4 is an explanatory diagram of an action definition file 401 showing a table defining the types of sensors, the number of sensors, and the CPU threshold value for each behavior status of a robot in the present embodiment. An administrator needs to define what service is provided (a behavior status, the types of sensors, and the number of sensors), and to what extent the quality of the provided service (CPU threshold value) is. The administration server has the action definition file 401 in which such a relationship thereamong is defined as a table in advance. The administration server reads the action definition file, and defines the types of sensors, the number of sensors, and a CPU threshold value for each behavior status as parameters based on the definition file. Next, the administration server periodically acquires a behavior status of the robot as sensor information from the robot, and refers to and compares the definition file with the acquired behavior status based on the behavior status, so as to define the types of sensors, the number of sensors, and the CPU threshold value.

### D. Control Corresponding to Behavior Status

When a robot is controlled with high accuracy, it is essential to perform resource management in which the CPU is taken into consideration. Therefore, it is necessary that the CPU resource of the robot determines a predetermined threshold value in advance so that a failure such as communication disconnection from the administration server due to deficiency of the CPU resource or an unstable state of robot control does not occur, and that the CPU resource of the robot drives the robot at a CPU use ratio which is equal to or less than the predetermined threshold value. A CPU load greatly depends on a behavior status of the robot, and is thus required to be set for each behavior status. If a CPU use ratio exceeds a predetermined CPU threshold value during a certain behavior status of the robot, a case is expected in which there is a high probability that a failure such as communication disconnection or an unstable state of robot control may occur. Therefore, in order to perform control so that a CPU use ratio does not exceed a predetermined CPU threshold value, it is necessary to dynamically change the number of sensors and the types of sensors required to control the robot according to a behavior status of the robot, and to dynamically change the number of requests, that is, a request interval for extracting sensor information based on the number of sensors, the types of sensors, and the behavior status of the robot.

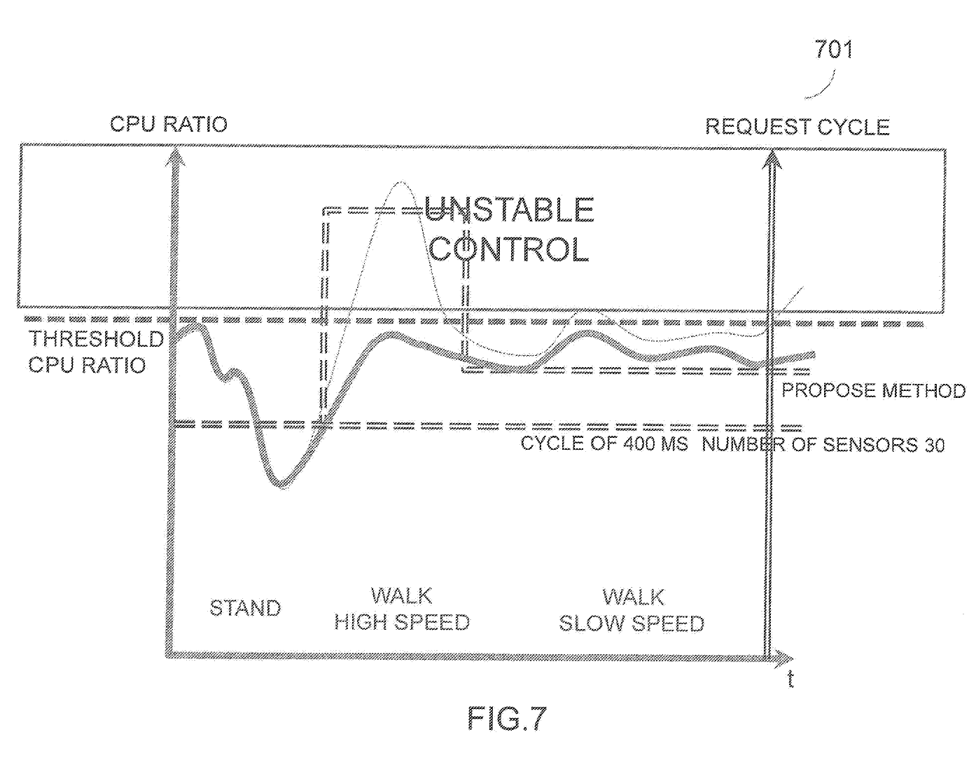

FIG. 7 is a diagram 701 for explaining control for dynamically changing a CPU load ratio and a request interval for each status of a robot in the present embodiment. The CPU load ratio is indicated by a solid line, the CPU threshold value is indicated by a dashed line, and a request cycle is indicated by a double dashed line.

Here, a case is assumed in which the administration server acquires sensor information stored in the RAM from the robot at a constant number of sensors and a constant request interval (for example, the number of sensors is 30, and the request interval is 400 ms). In other words, control is not performed so that the number of sensors and the request interval are dynamically changed. However, a behavior status of the robot is dynamically changed. In a case where a behavior status of the robot is changed from a “STAND” state to a “WALK” state in which a walking speed is high, if the number of sensors and the request interval are constant, the CPU use ratio exceeds the predetermined CPU threshold value, and thus communication disconnection between the administration server and the robot or an unstable state of robot control may occur. Then, a behavior status of the robot is changed to a “WALK” state in which a walking speed is low, the CPU use ratio is near the predetermined CPU threshold value. Also in this case, a probability that communication disconnection between the administration server and the robot or an unstable state of robot control may occur is not low. As mentioned above, if the number of sensors to be acquired and a request interval acquired from the robot are not controlled, communication disconnection between the administration server and the robot or an unstable state of robot control may occur, and thus a case may be expected in which a robot operation is impaired.

It is assumed previously that the administration server acquires sensor information from the robot at a constant number of sensors and a constant request interval (for example, the number of sensors is 30, and the request interval is 400 ms), but, in the present embodiment, the number of sensors and the request interval are assumed to be dynamically changed. In this case, unlike the previous case, in a case where a behavior status of the robot is changed from a “STAND” state to a “WALK” state in which a walking speed is high (WALK HIGH SPEED, WALK SLOW SPEED), if the number of sensors and the request interval are dynamically controlled so that a CPU use ratio is equal to or less than a predetermined threshold value, a probability that communication disconnection between the administration server and the robot and an unstable state of robot control may occur is considerably low, and it is possible to perform high quality resource management and highly accurate robot control.

For example, in a case where a behavior status of the robot is a “STAND” state, the number of sensors, the types of sensors, and the request interval for extracting sensor information stored in the RAM of the robot from the robot are dynamically changed and controlled. In this case, the number of sensors to be acquired is defined in a “STAND” state of a behavior status of the robot by referring to the action definition file defining the number of sensors which are acquired in advance for each behavior status. In the defined number of sensors, the type and the number of minimum required sensors are defined for each behavior status of the robot, and other sensor information is acquired through dynamic changing on a best effort basis. A relational expression thereof is as follows.

Nₛ>=Nₑ+N_{b} (16)

Nₛ: Number of sensors, Nₑ: Number of minimum required sensors, and N_{b}: Number of sensors to be acquired on best effort basis

In a case where a service is provided by operating a robot, a behavior status of the robot, and sensor information which is minimum required to be acquired, corresponding to the behavior status of the robot, are defined according to the service content. For example, in a case of a service in which the robot performs reception work instead of a human, it is expected that a behavior status of the robot is always a “SIT” state. In this case, when the reception work is performed, a customer's desire should be heard, and thus at least a voice recognition function needs to be activated. In this case, the robot may hear and recognize words spoken by the customer, and may transmit the words to the administration server. The administration server may retrieve a preferred answer through deep learning based on the words. Since face recording such as a facial expression, or a male or a female is important information in determining a variety of determinations in a case of providing a service, image data may be minimum required sensor information. However, sensors other than the two sensors may be defined as not always required sensors when performing the reception work. In this case, it is assumed that the sensors other than the two sensors are acquired under an instruction from the administration server depending on an appropriate situation. In this case, the CPU threshold value in a case where a behavior status of the robot is “SIT” is defined by referring to the action definition file, and, if the types of sensors and the number of sensors are defined, a request interval can be acquired from the relational expression.

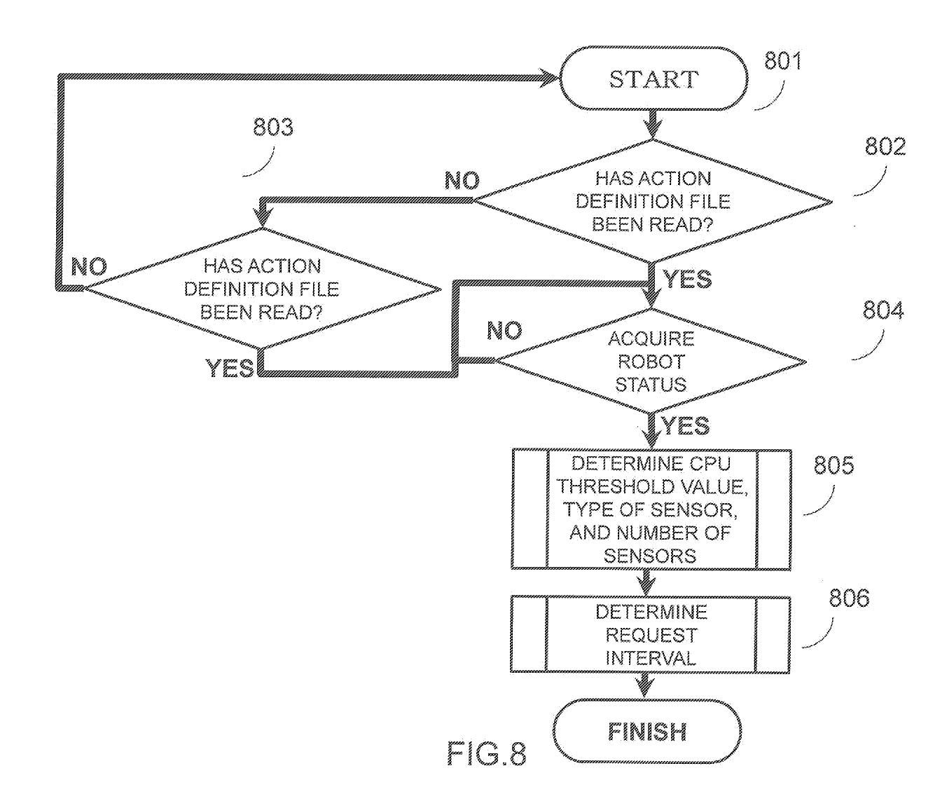

FIG. 8 is a flowchart for explaining a method in which the CPU threshold value, the number of sensors, and the types of sensors are defined according to a behavior status of a robot in a case where the administration server acquires sensor information stored in a RAM of the robot from the robot, and control is performed so that a CPU use ratio is equal to or less than the set CPU threshold value, in the present embodiment. The administrator needs to define what service is provided (a behavior status, the types of sensors, and the number of sensors), and to what extent the quality of the provided service (CPU threshold value) is. Such a relationship there among is defined as a table in advance, and the administration server stores the table as an action definition file in advance. First, the CPU 202 of the administration server checks whether or not the action definition file is being read (802), reads the action definition file if the action definition file is not being read, and defines the types of sensors, the number of sensors, and the CPU threshold value for each behavior status as parameters by referring to the definition file. If the action definition file fails to be read, the CPU 202 reads the action definition file again (803). Next, the CPU 202 of the administration server periodically acquires a behavior status of the robot stored in the RAM 201 from the robot as sensor information (804). The CPU 202 refers to the action definition file and reads and determines the types of sensors, the number of sensors, and the CPU threshold value according to the behavior status of the robot based on the acquired behavior status (805). Next, the CPU 202 calculates a request interval so that a CPU use ratio of the robot is equal to or less than a predetermined CPU threshold value based on a relational expression which will be described later, related to a behavior status, the types of sensors, the number of sensors, a request interval, and the CPU threshold value, which are calculated by carefully examining the robot in advance. Next, the CPU 202 of the administration server acquires sensor information from the robot at the calculated request interval.

### E. Relational Expression

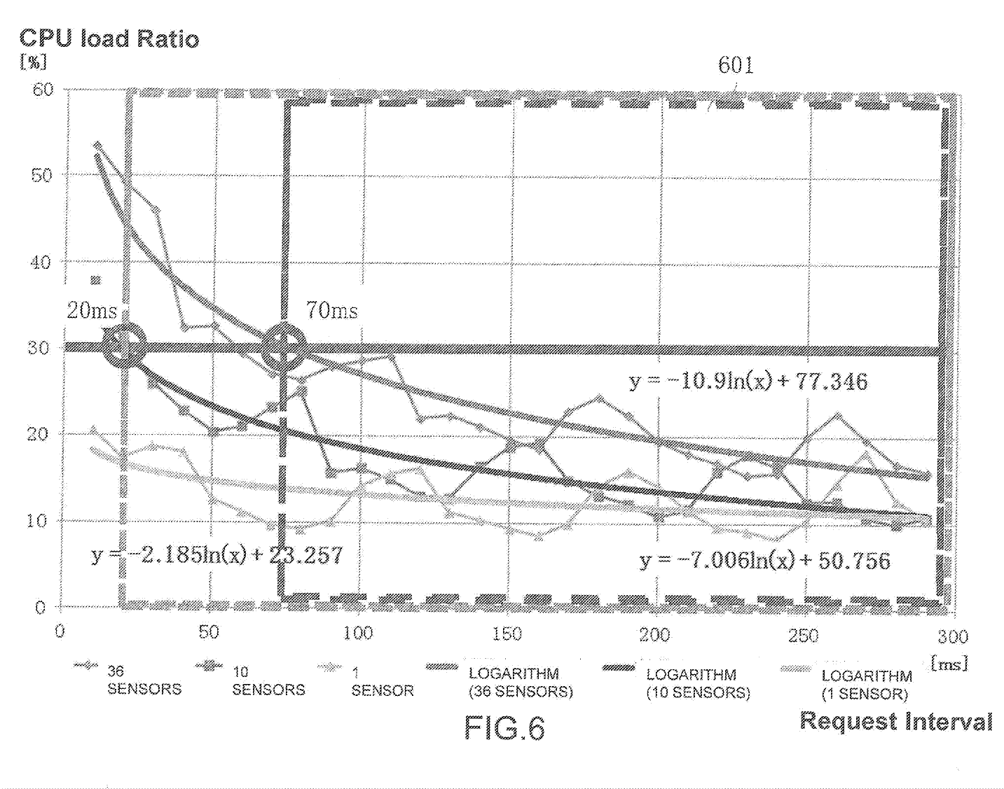

FIG. 6 shows a graph 601 for explaining a relationship among the types of sensors, the number of sensors, a cpu load ratio, and a request interval in the present embodiment. In the graph illustrated in FIG. 6, a transverse axis expresses a request interval, and a longitudinal axis expresses a CPU load ratio. This information is data acquired by carefully examining the robot in advance. A behavior status of the robot is data acquired in a “SIT” state. Regarding qualitative influence of a request interval on a CPU load, if the request interval is long, influence on the CPU load is small. Therefore, since the influence is expected to be reduced logarithmically, the acquired data is logarithmically approximated, and then a relational expression between the request interval and the CPU load ratio is derived. The relational expression is defined as follows.

Cᵣ=A*ln(req)+B (1)

req: Request interval, Cᵣ: CPU load ratio, A: Slope, and B: Intercept

From the graph of FIG. 6 and the qualitative viewpoint, as the number of sensors becomes larger, influence on a CPU load increases. Therefore, both of a slope and an intercept tend to increase as the number of sensors becomes larger, and thus a relational expression between the two parameters and the number of sensors may be derived through logarithmic approximation. Relational expressions of the slope and the intercept are defined as follows.

A=α_{A}*ln(N)+β_{A} (2)

B=α_{B}*ln(N)+β_{B} (3)

N: Number of sensors, A: Slope, B: Intercept, α_{A}: Slope in relational expression of A, β_{A}: Intercept in relational expression of A, α_{B}: Slope in relational expression of B, and β_{B}: Intercept in relational expression of B

A request interval can be derived from the CPU load ratio according to the relational expression shown in (1), and, in this case, the request interval can be obtained from the following equation.

req=exp((Cᵣ−B)/A) (4)

A: Slope, B: Intercept, req: Request interval, and Cᵣ: CPU load ratio

Equation (4) can be calculated by using Equations (2) and (3), that is, a request interval can be calculated based on the number of sensors.

As an example, a graph written as 36 sensors is a diagram illustrating a CPU load ratio of the robot in a case where sensor information of 36 types are acquired from the robot at each request interval expressed on the transverse axis. A relational expression between the request interval and the CPU load ratio in this case is as in the following equation.

Cᵣ=−10.9 ln(req)+77.346 (5)

req: Request interval, and Cᵣ: CPU load ratio

For example, in a case where the CPU load ratio is 30%, the administration server periodically acquires sensor information of 36 types from the robot at a request interval of 70 ms. In other words, in a case where the sensor information of 36 types are acquired, if the CPU load ratio is desired to be equal to or less than 30%, the information may be periodically acquired from the robot at a request interval of 70 ms or more. In other words, this indicates that the minimum request interval at 30% or less is 70 ms.

As another example, a graph written as 10 sensors is a diagram illustrating a CPU load ratio of the robot in a case where sensor information of 10 types are acquired from the robot at each request interval expressed on the transverse axis. A relational expression between the request interval and the CPU load ratio in this case is as in the following equation.

Cᵣ=−7.006 ln(req)+50.756 (6)

req: Request interval, and Cᵣ: CPU load ratio

In the same manner as in the 36 types, in a case where the CPU load ratio is 30%, the administration server periodically acquires sensor information of 10 types from the robot at a request interval of 20 ms. In other words, in a case where the sensor information of 10 types are acquired, if the CPU load ratio is desired to be equal to or less than 30%, the information may be periodically acquired from the robot at a request interval of 20 ms or more. In other words, this indicates that the minimum request interval at the CPU load ratio of 30% or less is 20 ms.

Here, relational expressions between a slope and an intercept, and the number of sensors are derived by using Equations (5) and (6). In this case, the relational expressions between the number of sensors, and a slope and an intercept are as in the following equations according to Equations (5) and (6), and Equations (2) and (3).

A=−2.427 ln(N)−1.925 (7)

B=14.67 ln(N)+21.214 (8)

A: Slope, B: Intercept, and N: Number of sensors

If the number of sensors and a CPU load ratio can be defined by using Equations (7) and (8), and Equation (4), the minimum request interval at that time can be defined.

The sensor information acquired here is assumed to be sensor information in which only a value such as temperature data is transmitted to the administration server without taking into consideration image data such as a moving image and voice data such as a voice. If image data such as a moving image and/or voice data such as a voice are (is) taken into consideration, the sensor information has great influence on a CPU load since there is a difference in an information amount from other sensor information, and thus it is necessary to carefully examine a relationship between a request interval based on image data and/or voice data and a CPU load ratio so that a new relational expression is derived. In a case where image data which is different from other sensor information is acquired, it is known from various tests that a load ratio increases by, for example, about 10%. A relational expression between the request interval and the CPU load ratio in this case may be calculated as follows in a case of taking into consideration influence of the image data on the CPU load ratio.

Cᵣ=−10.9 ln(req)+77.346+Cₚ (9)

req: Request interval, Cᵣ: CPU load ratio, and Cₚ: CPU load ratio (for example, 10%) due to image

A request interval can be derived from the CPU load ratio according to the relational expression shown in (4), and, in this case, the request interval can be obtained from the following equation.

req=exp((Cᵣ−B−Cₚ)/A) (10)

A: Slope, B: Intercept, req: Request interval, Cᵣ: CPU load ratio, and Cₚ: CPU load ratio (for example, 10%) due to image

Equation (10) can be calculated by using Equations (2) and (3), that is, a request interval can also be calculated based on the number of sensors in a case where image data having great influence on the CPU is acquired from the robot. If a voice recognition function is activated, a load ratio increases by about 10%. A relational expression between a request interval and a CPU load ratio in this case may be calculated as in the following equation in a case of taking into consideration influence of voice recognition on the CPU load ratio.

Cᵣ=−10.9 ln(req)+77.346+Cₛ (11)

req: Request interval, Cᵣ: CPU load ratio, and Cₛ: CPU load ratio (10%) due to voice recognition

A request interval can be derived from the CPU load ratio according to the relational expression shown in (4), and, in this case, the request interval can be obtained from the following equation.

req=exp((Cᵣ−B−Cₛ)/A) (12)

A: Slope, B: Intercept, req: Request interval, Cᵣ: CPU load ratio, and Cₛ: CPU load ratio (10%) due to voice recognition

Equation (12) can be calculated by using Equations (2) and (3), that is, a request interval can also be calculated based on the number of sensors in a case where voice recognition having great influence on the CPU is activated.

In a case where the robot transitions from a “SIT” state to a “WALK” state, a load ratio is, for example, 10% higher in the “WALK” state than in the “SIT” state. A relational expression between a request interval and a CPU load ratio in this case may be calculated as in the following equation in a case of taking into consideration influence of “WALK” as a behavior status of the robot on a CPU load.

Cᵣ=−7,006 ln(req)+50.756+C_{w} (13)

req: Request interval, Cᵣ: CPU load ratio, and C_{w}: CPU load ratio (10%) due to walking

A request interval can be derived from the CPU load ratio according to the relational expression shown in (4), and, in this case, the request interval can be obtained from the following equation.

req=exp((Cᵣ−B−C_{w})/A) (14)

A: Slope, B: Intercept, req: Request interval, Cᵣ: CPU load ratio, and C_{w}: CPU load ratio (for example, 10%) due to walking

Equations (10), (12) and (14) are combined with each other, and a relational expression for calculating a request interval from the number of sensors is as follows.

req=exp((C_{Th}−B−C_{w}−Cₚ−Cₛ)/A) (15)

N: the number of sensors, A: Slope, B: Intercept, C_{Th}: CPU threshold value, and C_{w}: CPU load ratio due to walking Cₚ: CPU load ratio due to image, Cₛ: CPU load ratio due to voice recognition, and req: Request cycle

A request interval is calculated from the number of sensors by using the above Equation (15). The number of sensors may be defined from a request interval by using the above equation.

### F. Sending of Request to Robot

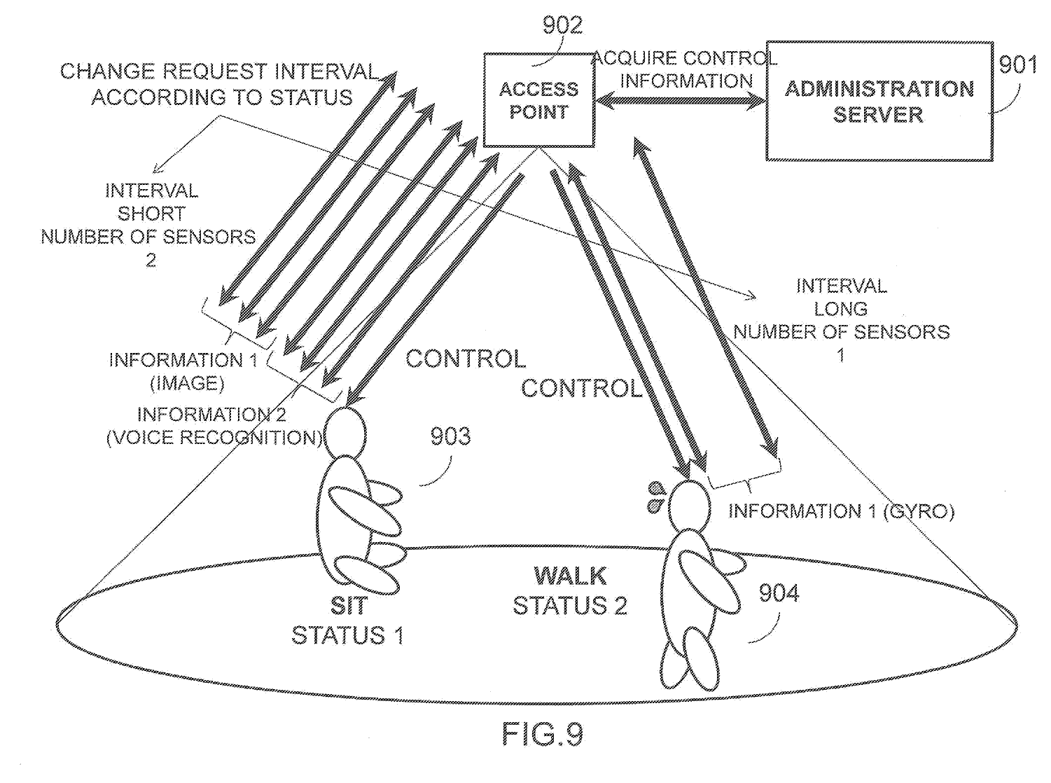

FIG. 9 is a diagram for explaining an operation summary of a system according to the present embodiment. The system includes an administration server 901, an access point (wireless LAN base station) 902, and robots 903 and 904. The administration server manages and controls a plurality of robots. In order to perform highly accurate control, it is essential to perform a control method such as a closed loop control method in which the administration server acquires various information from the robot, and performs control based on the information. However, in a case where the administration server acquires various and specific sensor information, it is necessary that the administration server frequently sends requests to the robot. In this case, a request interval for acquiring much and specific sensor information is very short, a CPU use ratio of the robot increases unlimitedly, there is a high probability that communication disconnection between the administration server and the robot or an unstable state of robot control may occur, and RAS indicating reliability, availability, and serviceability in a robot system is very low. In order to perform highly accurate control in which RAS is high, it is essential to perform resource management in which the CPU is taken into consideration, and thus it is necessary to operate the CPU resource of the robot efficiently. Therefore, in order to increase RAS, the types of sensors or the number of sensors is defined in advance for each behavior status of a robot, a request interval at which the administration server extracts sensor information from the robot is calculated by using a relational expression which is derived through careful examination in advance, and performs control so that a CPU use ratio is equal to or less than a predetermined CPU threshold value.

The administration server can control the robot not only through wired communication but also through wireless communication. In this case, the administration server dynamically changes the types of sensors or the number of sensors, and a request interval for acquiring sensor information from the robot based on the intensity of a radio wave. It is very important to dynamically change the types of sensors or the number of sensors, and a request interval for acquiring sensor information from the robot based on the intensity of a radio wave in order to increase RAS of the system. In other words, since a probability of the occurrence of a packet loss is low at a location where radio intensity is high, control is performed so that the administration server acquires many types and a large number of sensors from the robot at a high frequency. Conversely, since a probability of the occurrence of a packet loss is high at a location where radio intensity is low, high priority is given to only the types of sensors, the number of sensors to be acquired is reduced as much as possible, and control is performed so that a request interval for the administration server acquiring sensor information from the robot is set to be as long as possible. However, if a request interval is set to be too long, QoS regarding a robot service is lowered, and thus control is performed so that a request interval is set to be long to the extent to which minimum QoS is ensured.

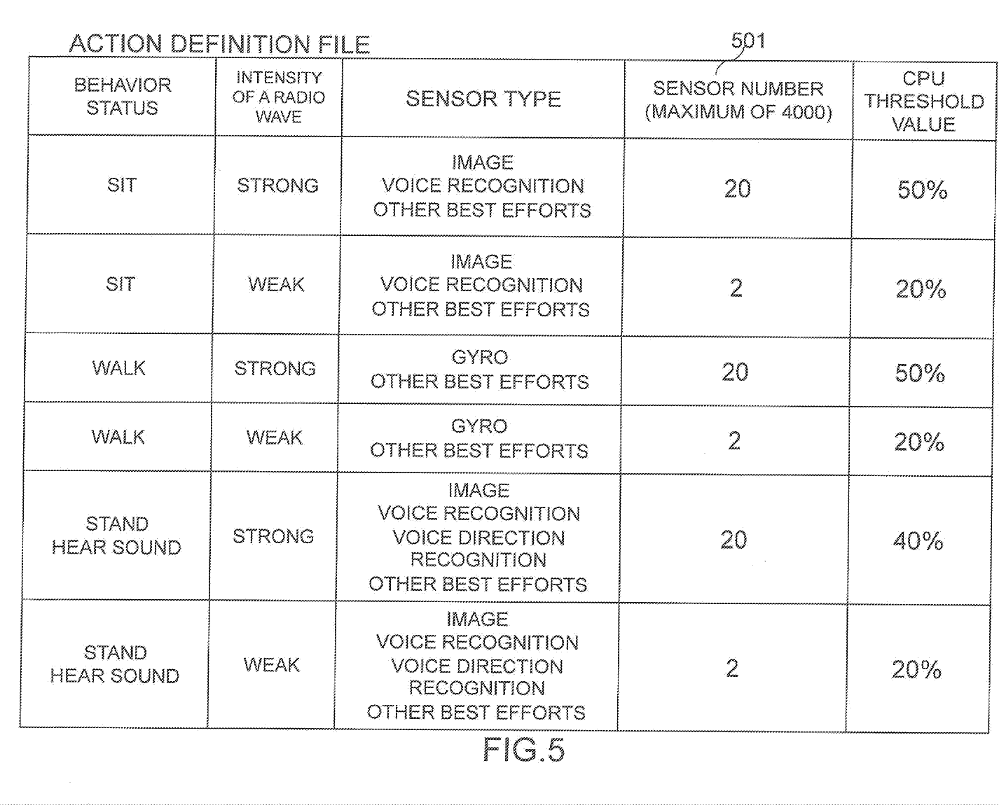

FIG. 5 is an explanatory diagram of an action definition file 501 showing a table in which the types and the number of sensors, and the CPU threshold value for each set of a behavior status and radio wave intensity of a robot in the present embodiment. It is necessary that the administrator defines what service is provided (a behavior status, the types of sensors, and the number of sensors), and to what extent the quality of the provided service (CPU threshold value) is. The robot is controlled not only through wired communication but also through wireless communication, and thus the intensity of a radio wave is also required to be taken into consideration. For example, in a case where a radio wave is strong, a large number of sensors to be acquired are defined, and, in a case where a radio wave intensity is weak, only information regarding minimum required sensors is defined to be acquired. At a location where the radio wave intensity is high, a probability of the occurrence of a packet loss is low, and communication can be performed with high reliability. Therefore, in a case where the electric wave intensity is high, much sensor information is preferably acquired. Conversely, in a case where the radio wave intensity is low, a lot of packet losses occur, and thus only minimum required sensor information is preferably acquired.

In a case of taking into consideration of the radio wave intensity, the action definition file illustrated in FIG. 5 is used in the flowchart of FIG. 8. In step 805, the CPU acquires the radio wave intensity, and reads and determines the types of sensors, the number of sensors, and the CPU threshold value corresponding to the behavior status and the radio intensity.

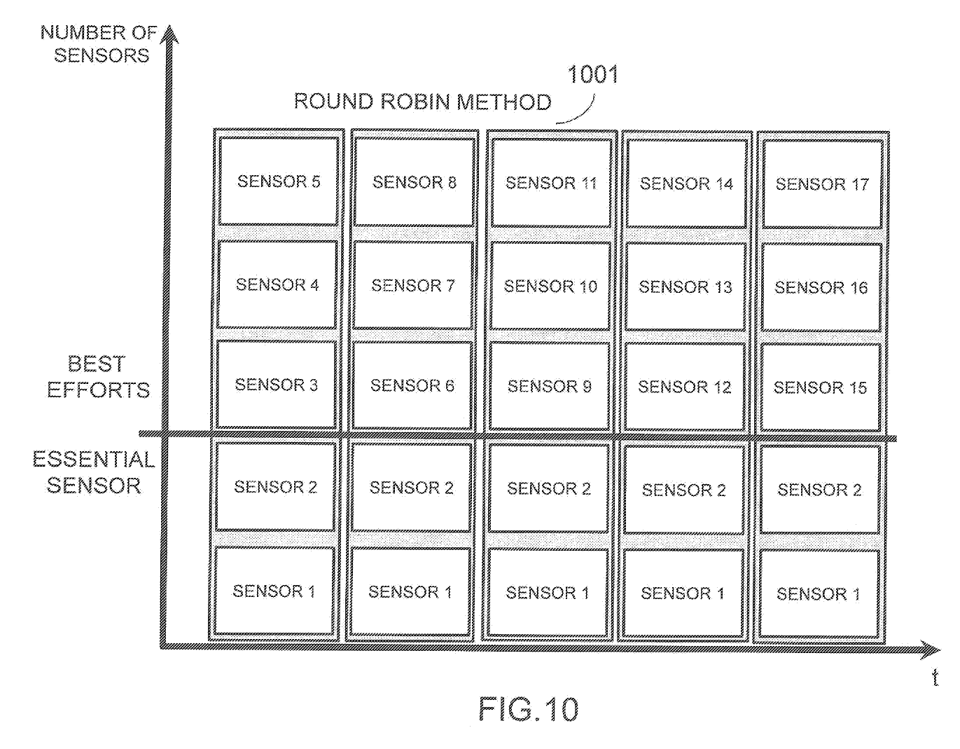

FIG. 10 is a diagram 1001 for explaining that the types of sensors and the number of sensors are dynamically changed and controlled in the present embodiment. The algorithm for determining a request interval has been described hitherto, and a description will be made of a control method for acquiring sensor information after a request interval is determined. In this case, there is a method in which the robot appropriately determines the number of sensors and the types of sensors depending on a situation, but, here, sensors to be acquired on a best effort basis indicate that all sensor information of the robot is acquired in a round-robin manner. Herein, as an example, a description will be made of a case where, if the number of sensors is five in an action definition file, as types of the sensors, the number of minimum required sensors (for example, an image and voice recognition) is two, and the number of other sensors on a best effort basis is three. In FIG. 10, assuming that five sensors are to be secured, the CPU of the administration server always secures two minimum required sensors, but, as sensors acquired on a best effort basis, first secures a sensor 3, a sensor 4, and a sensor 5, and secures a sensor 6, a sensor 7, and a sensor 8 next, as illustrated in FIG. 10. As mentioned above, this example assumes that the sensors are sequentially acquired up to the maximum number of sensors provided in the robot. The CPU sends a request to each secured sensor at a request interval.

### G. Request Interval for Each Sensor or Each Sensor Group

Hereinafter, a description will be made of a method in which the administration server (CPU) sets a request interval for each sensor or each sensor group (cluster) based on a calculated request interval. The administration server (CPU) stores each set request interval in a request interval table, and sends a request to each sensor or each sensor group by referring to the table.

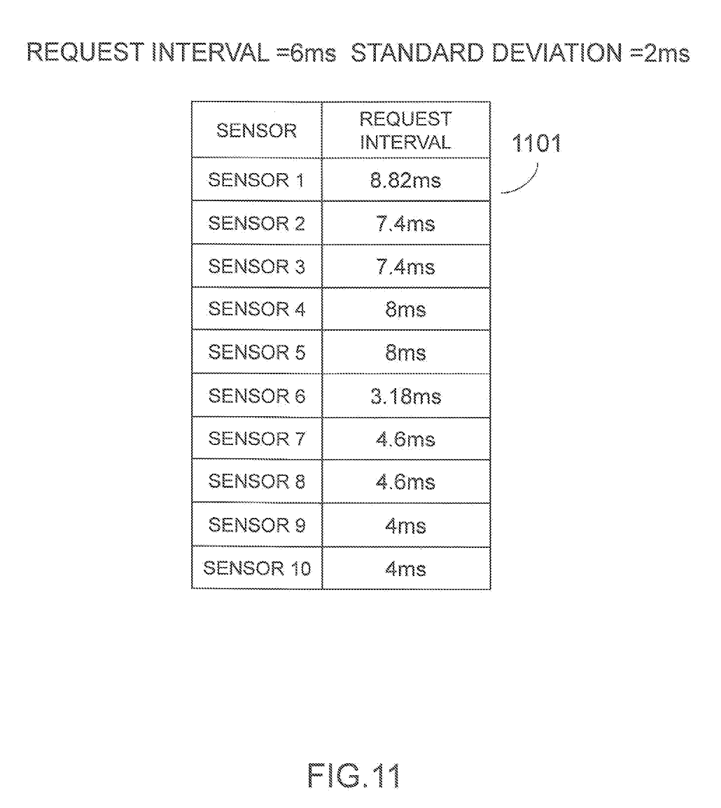

FIG. 11 is a diagram 1101 for explaining a request interval table defining a request interval for each sensor in a case where the number of sensors to be acquired is ten in the present embodiment. In the above-described method of acquiring sensors, the same request interval is applied to all of the acquired sensors, but, in this example, a request interval may be set for an individual sensor. In this case, there may be a method in which the administration server (CPU) calculates a request interval from the number of sensors by using the above equation (Equation (4), (10), (12), (14), (15), or the like), uses the calculated request interval as an average, defines a predetermined standard deviation or a variance and then defines a distribution, and allocates the request interval at random according to the distribution. In this case, regarding a specific allocation method, a distribution is assumed to be a distribution which is bilaterally symmetric with respect to an average, and the number of sensors is first defined. In that case, a left set of the distribution is defined as a negative set, and a right set of the distribution is defined as a positive set. The number of positive sets and the number of negative sets are defined to be the same as each other, and are thus defined as follows.

X=Y=N/2 (17)

X: Number of positive sets, Y: Number of negative sets, and N: Number of sensors

Next, the number of positive sets or the number of negative sets is applied to a variance, and thus a sum total of variations is calculated. A relational expression thereof may be defined as in the following Equations (18), (19) and (20).

σ̂2*N/2=σ̂2*X=σ̂2*Y=Σ(xᵢ−m)² (18)

σ̂2: Variance, N: Number of sensors, xᵢ: Request interval for each sensor, m: Average of request intervals of positive sets or negative sets, X: Number of positive sets, and Y: Number of negative sets

Σσ̂2*Rᵢ=Σ(xᵢ−m)²=σ̂2*X=σ̂2*Y (19)

ΣRᵢ=X=Y=N/2 (20)

σ̂2: Variance, Rᵢ: Proportion for variance for defining variation of each sensor, xᵢ: Request interval for each sensor, and m: Average of request intervals of positive sets or negative sets

The administration server (CPU) defines each variation after calculating the sum total of variations, and calculates each request interval of the positive sets. Each variation is computed by applying a certain proportion based on the variance. Each request interval is calculated by adding a standard deviation which is calculated by using a random number, to the average of the request intervals. Here, an added standard deviation is positive in a case of the positive sets, and an added standard deviation is negative in a case of the negative sets. In order to compute the standard deviation, each variation is computed by using a random number. A sum total of the respective variations are computed by using random numbers, so as to be the same as the previously calculated sum total of variations. A relational expression thereof is defined as in Equation (21). Here, when respective request intervals of the positive sets and the negative sets are computed, the request intervals are sequentially computed, but the last request interval is computed by using Equation (22) without using a random number.

(xᵢ−m)²=(ΣRᵢ−ΣRⱼ)*random(0−1) (21)

(xᵢ−m)²=(ΣRᵢ−ΣRⱼ) (22)

σ̂2: Variance, (xᵢ−m)²: Variation between each request interval and average in positive set, ΣRᵢ: Sum total of variations of positive sets or negative sets, ΣRⱼ: Computed sum total of variations, Request interval for each sensor, and m: Average of request intervals of positive sets or negative sets, X: Number of positive sets

The administration server (CPU) can define a request interval for each sensor by using the equations. A specific example will be described below. For example, as illustrated in FIG. 11, as an example, an average of request intervals is defined as 6 ms, and a variance is defined as 4. In this case, the number of positive sets and the number of negative sets is 10/2=5 according to Equation (19). Next, a sum total of proportions for a variance for defining a variation of each sensor is 5 according to Equation (17). The administration server (CPU) computes a variation between each request interval and the average. A random number is appropriately defined this time, and a computation result is as follows by using Equations (21) and (22).

Proportion for variance of sensor 1:(5−0)*random number(0.4)=2

Proportion for variance of sensor 2:(5−2)*random number(0.166)=0.5

Proportion for variance of sensor 3:(5−2.5)*random number(0.2)=0.5

Proportion for variance of sensor 4:(5−3)*random number(0.5)=1

Proportion for variance of sensor 5:(5−4)=1

A standard deviation may be computed as follows based on the proportion.

Standard deviation of sensor 1:standard deviation=sqrt(4*2)=2.82 [ms]

Standard deviation of sensor 2:standard deviation=sqrt(4*0.5)=1.4 [ms]

Standard deviation of sensor 3:standard deviation=sqrt(4*0.5)=1.4 [ms]

Standard deviation of sensor 4:standard deviation=sqrt(4*1)=2 [ms]

Standard deviation of sensor 5:standard deviation=sqrt(4*1)=2 [ms]

Therefore, regarding request intervals in the positive sets are as follows.

Request interval of sensor 1:request interval=6 [ms]+2.82 [ms]=8.82 [ms]

Request interval of sensor 2:request interval=6 [ms]+1.4 [ms]=7.4 [ms]

Request interval of sensor 3:request interval=6 [ms]+1.4 [ms]=7.4 [ms]

Request interval of sensor 4:request interval=6 [ms]+2 [ms]=8 [ms]

Request interval of sensor 5:request interval=6 [ms]+2 [ms]=8 [ms]

Regarding request intervals in the negative sets, using the above result are as follows.

Request interval of sensor 6:request interval=6 [ms]−2.82 [ms]=3.18 [ms]

Request interval of sensor 7:request interval=6 [ms]−1.4 [ms]=4.6 [ms]

Request interval of sensor 8:request interval=6 [ms]−1.4 [ms]=4.6 [ms]

Request interval of sensor 9:request interval=6 [ms]−2 [ms]=4 [ms]

Request interval of sensor 10:request interval=6 [ms]−2 [ms]=4 [ms]

A request interval can be defined for each sensor as mentioned above. This is only an example, and other setting methods may be employed.

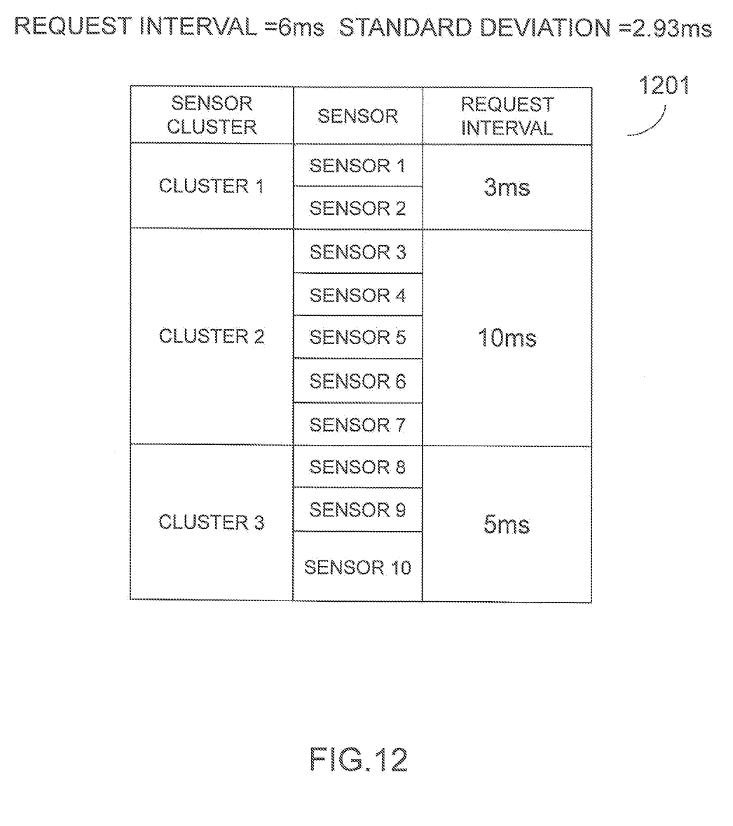

FIG. 12 is a diagram for explaining a request interval table 1201 which is obtained in such a manner that the administration server reads plural pieces of sensor information stored in the RAM of the robot from the robot, clusters the sensor information, and defines a request cycle for each cluster, in the present embodiment. The administration server (CPU) may use a request interval calculated from the number of sensors, as an average, define a predetermined standard deviation or a variance and then defines a distribution by the above Equations (17) to (22), and set a request cycle for each cluster according to the distribution.

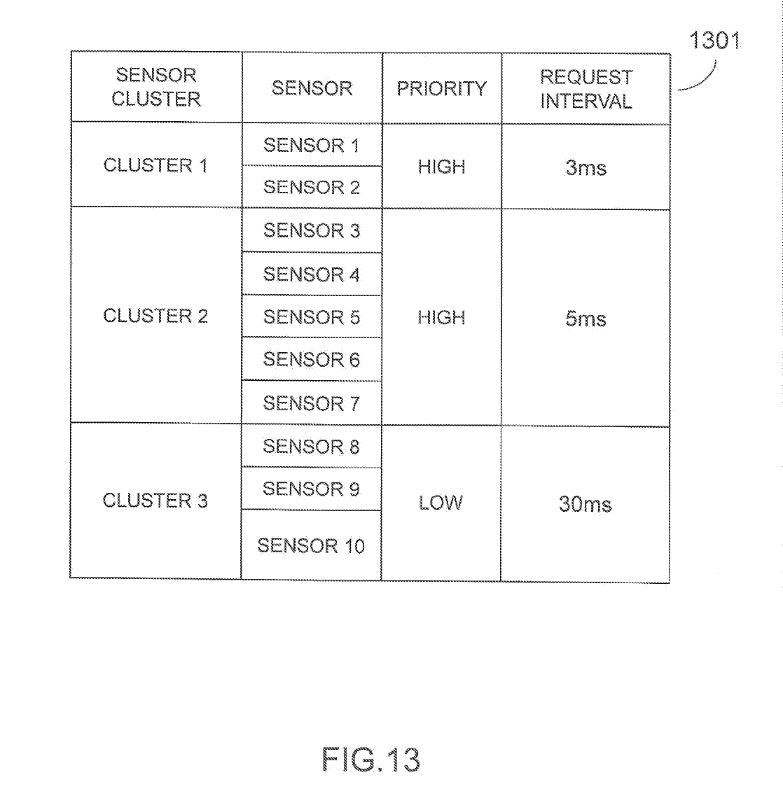

FIG. 13 is a diagram for explaining a request interval table 1301 which is obtained in such a manner that the administration server clusters plural pieces of sensor information stored in the RAM of the robot from the robot, defines a request interval for each cluster, and further defines the priority for each cluster, in the present embodiment. The administration server (CPU) may set an request interval for each cluster by using the above Equations (17) to (22), and also set the priority for each cluster. For example, the administration server (CPU) defines a standard deviation or a variance in advance, and computes a request interval for each cluster in advance by using the above Equations (17) to (22). In the request interval table, in a state in which a behavior status of the robot is “WALK”, the priority of a cluster 2 obtained by clustering sensor information acquired from a plurality of sonars provided in the robot is set to be high in consideration of human safety, and the priority of a cluster 3 obtained by clustering temperatures of various actuators is set to be low. The administration server (CPU) may set a request interval based on the priority so that a shorter request interval among request intervals which are computed in advance is set for a higher priority. In this case, the priority is initially determined, and then a request interval is allocated.

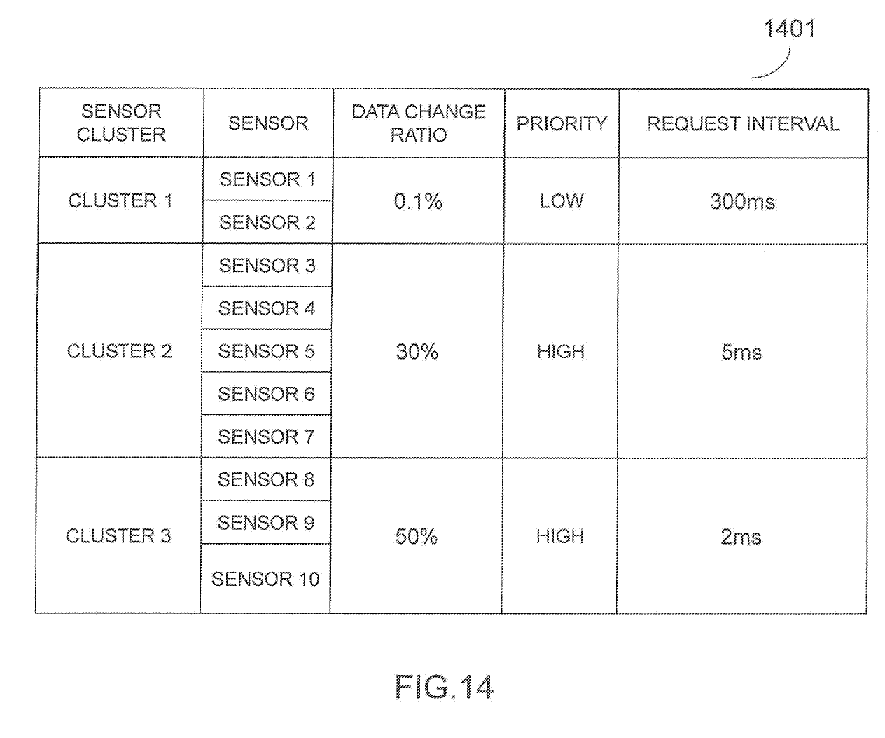

FIG. 14 is a diagram for explaining a request interval table 1401 which is obtained in such a manner that the administration server clusters plural pieces of sensor information stored in the RAM of the robot from the robot, defines a request interval for each cluster, further defines the priority for each acquired cluster, and still further defines a data change ratio of acquired sensor information, in the present embodiment. Here, the data change ratio is data indicating the extent of change in time-series data of acquired sensor information when compared with data at the previous time point. A relational expression of the data change ratio is as follows.

Dᵣ=D_{c}/Dₚ*100 (23)

Dᵣ: Data change ratio, D_{c}: Instantaneous value, and Dₚ: Previous data in time-series data

The administration server (CPU) may calculate an average value for each cluster based on information regarding each data change ratio, and set the priority for each cluster according to the average value. For example, if an average data change ratio of a certain cluster is, for example, 500%, the administration server (CPU) may set the priority for acquiring data of the cluster to be high, and set a short request interval so that the administration server acquires specific data of the cluster from the robot.

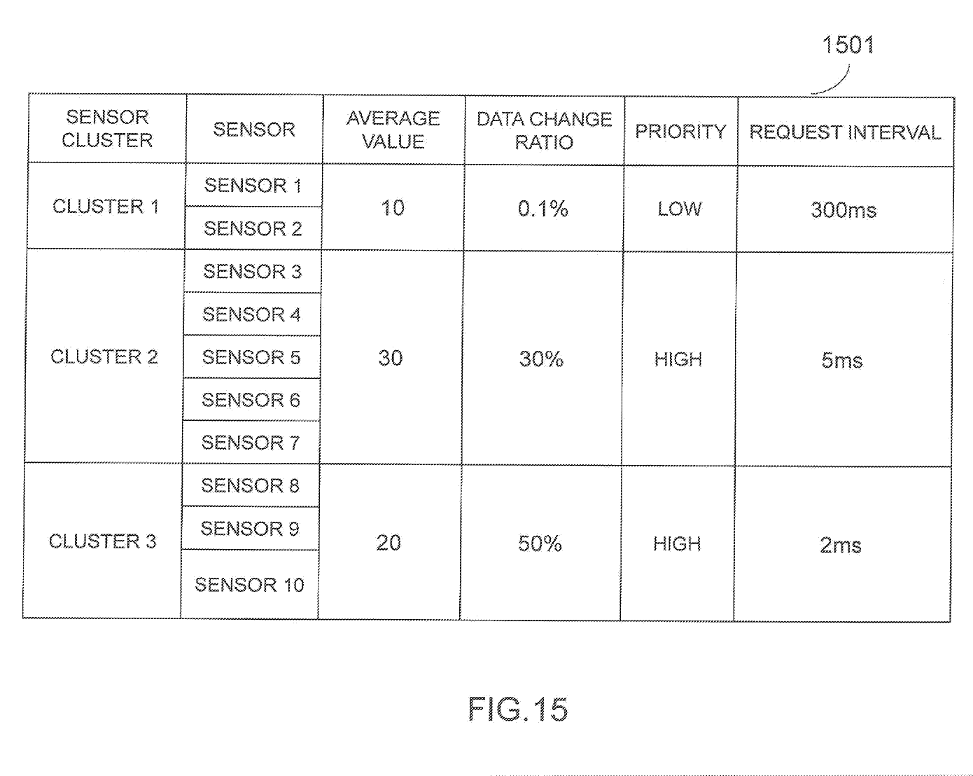

FIG. 15 is a diagram for explaining a request interval table 1501 which is obtained in such a manner that the administration server clusters plural pieces of sensor information stored in the RAM of the robot from the robot, defines a request interval for each cluster, further defines the priority for each acquired cluster, still further defines a data change ratio of acquired sensor information for each cluster, and defines an average value for each cluster, in the present embodiment. For example, in a case where there is a temperature information cluster formed of temperature information of the respective actuators, the administration server (CPU) may calculate an average value of the temperatures, and, if the average value is equal to or greater than a predetermined threshold value, set the priority of the temperature information cluster to be high, and set a short request interval so that the administration server acquires specific data of the cluster from the robot.

### H. Aggregation Function

In the above-described embodiment, the administration server side performs resource management of the CPU resource which changes a request interval for extracting sensor information stored in the RAM from the robot, but, in the following embodiment, a robot additionally has an aggregation function of aggregating information which is transmitted by the robot in the above-described embodiment.

In a case where the robot transmits sensor information to the administration server, a large amount of sensor information is transmitted to the administration server in order to manage a plurality of robots. In this case, the administration server measures an amount of the information transmitted from the robots as a throughput, and transmits a control command for aggregating transmission packets from the administration server to the robot in a case where the measured throughput is equal to or more than a predetermined threshold value. The robot having received the control command aggregates information having low priority and transmits the aggregated information to the administration server, and thus an operation load on the administration server operating a plurality of robots can be reduced. If specific information is to be known, sensor information may be transmitted without being aggregated. In this case, the administration server transmits a control command for not aggregating information, to the robot.

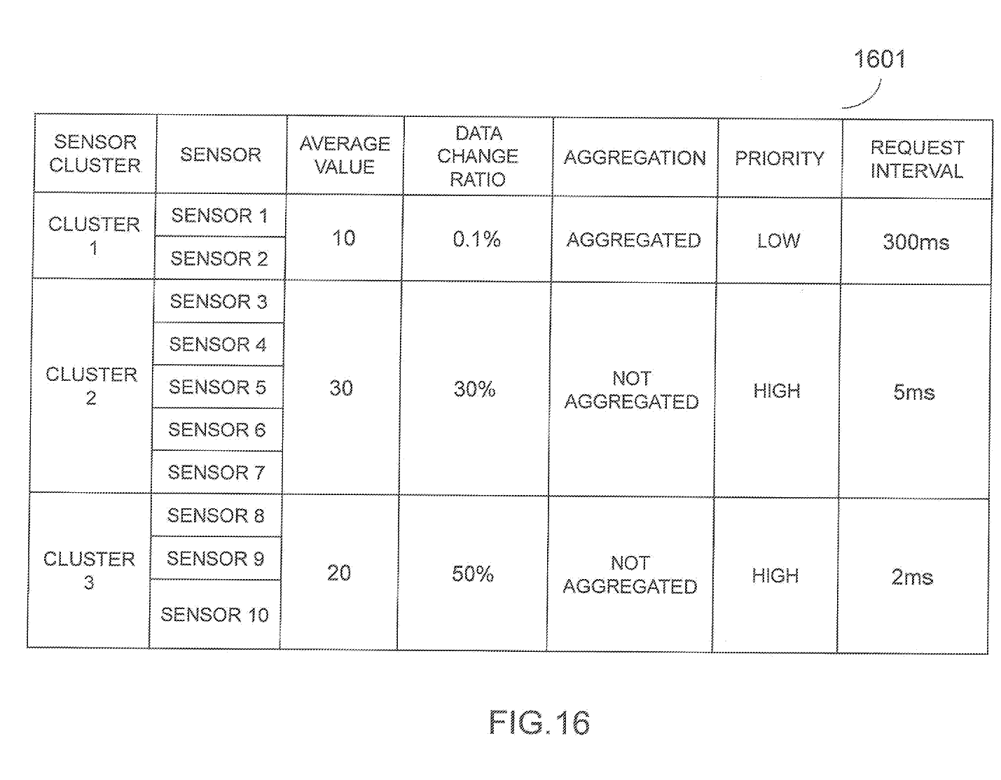

FIG. 16 is a diagram for explaining a request interval table 1601 which is obtained in such a manner that the administration server clusters plural pieces of sensor information stored in the RAM of the robot from the robot, defines a request interval for each cluster, further defines the priority for each acquired cluster, still further defines a data change ratio of acquired sensor information, and even further defines whether or not sensor information is aggregated when the robot transmits the sensor information, in the present embodiment. Whether or not aggregation is performed greatly depends on a data change ratio for each cluster, or the priority of each cluster determined according to an average value. Here, the administration server (CPU) defines, for example, a cluster having low priority to be aggregated.

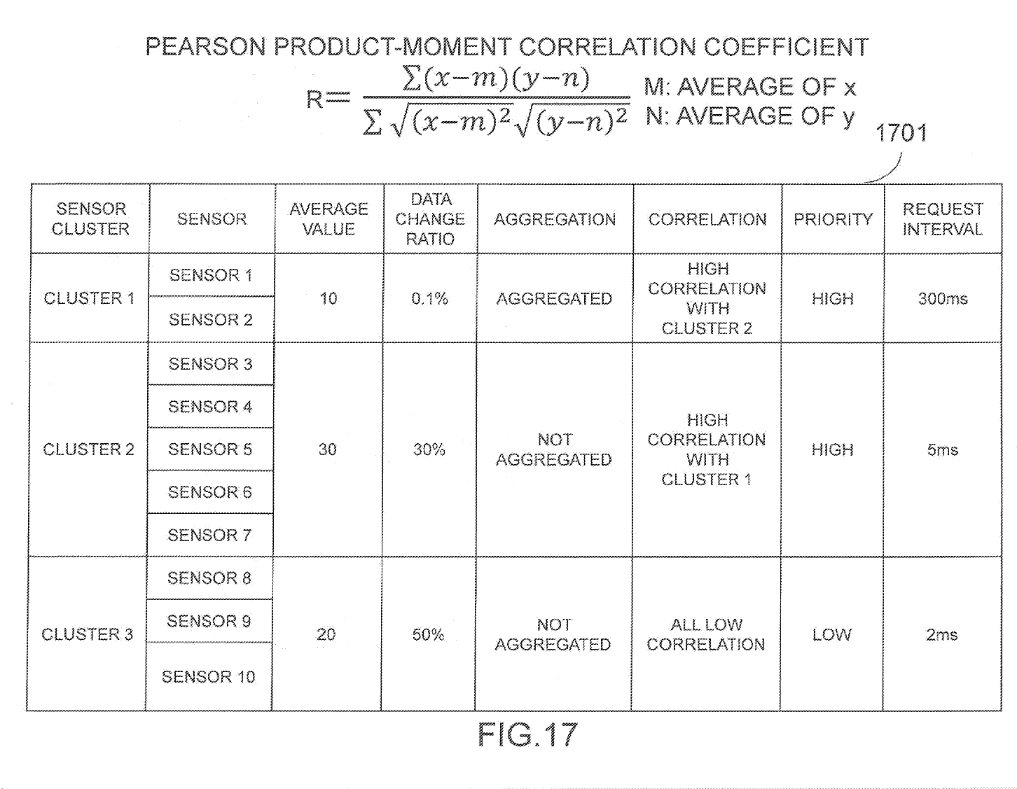

FIG. 17 is a diagram for explaining a request interval table 1701 which is obtained in such a manner that the administration server clusters plural pieces of sensor information stored in the RAM of the robot from the robot, defines a request interval for each cluster, further defines the priority for each acquired cluster, still further defines a data change ratio of acquired sensor information, and even further defines a cluster having the highest correlation through computation of a correlation coefficient among clusters based on time-series data of each piece of sensor information distributed to the clusters, in the present embodiment. Time-series data of an average value for each cluster is used to calculate a correlation coefficient among the clusters. The administration server (CPU) acquires an average value for each cluster in time series, and calculates an average value of the time-series data of the average value for the cluster. The administration server (CPU) computes a Pearson product-moment correlation coefficient by using average values of the time-series data of two clusters. The Pearson product-moment correlation coefficient is computed by using the following Equation (24).

$$r = \frac{\sum ( x - m ) ( y - n )}{\sum \sqrt{{( x - m )}^{2}} \sqrt{{( y - n )}^{2}}} \qquad ( 24 )$$

x: Any time-series data 1, y: Any time-series data 2, m: Average of x, and n: Average of y

The administration server (CPU) computes correlation coefficients of all clusters, and calculates a cluster having the greatest positive correlation coefficient. If the cluster having a high correlation is defined in the request interval table in advance as mentioned above, in a case where specific data of a cluster having a high data change ratio is acquired, specific data of a cluster having a high correlation with the cluster can be acquired. As an example, since a cluster 1 and a cluster 2 have a high correlation therebetween in the table, in a case where a data change ratio of the cluster 1 is very high, and the priority for acquiring sensor information of the cluster is high, the priority of the cluster 2 having the high correlation may also be set to be high.

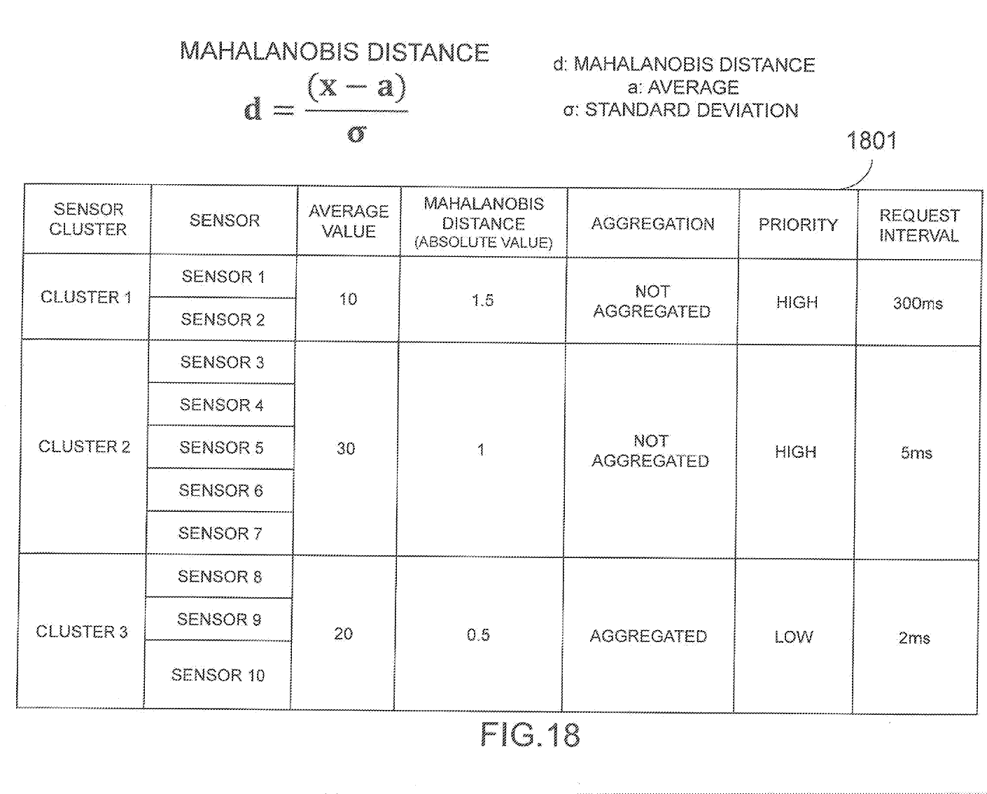

FIG. 18 is a diagram for explaining a request interval table 1801 which is obtained in such a manner that the administration server clusters plural pieces of sensor information stored in the RAM of the robot from the robot, defines a request interval for each cluster, further defines the priority for each acquired cluster, still further defines a data change ratio of acquired sensor information, and even further defines a Mahalanobis distance for each cluster based on time-series data of the acquired sensor information, in the present embodiment. Time-series data of an average value for a cluster is used to calculate the Mahalanobis distance. The administration server (CPU) acquires an average value for each cluster in time series, and computes an average value and a standard deviation by using the time-series data of the average value for the cluster. The Mahalanobis distance is computed according to the following Equation (25).

d=(x−a)/σ (25)

d: Mahalanobis distance, a: Average value of time-series data, σ: Standard deviation, and x: Instantaneous value of time-series data

The administration server (CPU) calculates the Mahalanobis distance based on the time-series data for each cluster, and sets the priority of a cluster to be high in a case where the Mahalanobis distance of the cluster exceeds a predetermined threshold value. A request interval of the cluster whose priority is set to be high may be set to be short so that the administration server acquires specific data of the cluster from the robot.

### I. Effects of Embodiment

According to the present embodiment, the types of sensors, the number of sensors, and the CPU threshold value of an IoT apparatus are determined according to a state of the apparatus, a request interval for extracting sensor information stored in a RAM of the IoT apparatus is set not to exceed the predetermined CPU threshold value, and thus it is possible to prevent an unstable state of control of the IoT apparatus or communication disconnection due to a deficient resource.

### J. Additional Statements

Although the present disclosure has been described with reference to exemplary embodiments, those skilled in the art will recognize that various changes and modifications may be made in form and detail without departing from the spirit and scope of the claimed subject matter. For example, in the above-mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions, processors, processing means may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (solid state drive), or a storage medium such as an IC card, an SD card, or a DVD.

Also, the control lines and the information lines necessary for description are illustrated, and all of the control lines and the information lines necessary for products are not illustrated. In fact, it may be conceivable that most of the configurations are connected to each other.

What is claimed is:

1. An administration server comprising:
an action definition file in which the number of sensors, types of sensors, and a CPU threshold value are stored in advance with respect to a behavior state of an apparatus having a plurality of sensors; and
a processing unit,
wherein the processing unit
acquires a behavior state of the apparatus,
refers to the action definition file, and determines the number and types of a plurality of sensors which acquire data from the apparatus, based on the number of sensors and the types of sensors for the behavior state of the apparatus, and
determines a request interval for requesting a data acquisition of the plurality of sensors so that a CPU use ratio of the apparatus does not exceed the CPU threshold value by the number of sensors.

2. The administration server according to claim 1,
wherein the types of sensors in the action definition file include types and the number of one or a plurality of sensors which are minimum required, and
wherein the processing unit refers to the action definition file, always secures one or a plurality of sensors which are minimum required at each request interval according to the number of sensors and the request interval determined, sequentially extracts a plurality of sensors other than the sensors data of which are minimum required among all of the sensors, and sends a request to the apparatus.

3. The administration server according to claim 2,
wherein the processing unit uses a request interval as an average value for each of the plurality of sensors, and determines a request interval for each sensor based on a predetermined variance or standard deviation.

4. The administration server according to claim 2,
wherein the processing unit uses a request interval as an average value for each predetermined sensor group, and determines a request interval for each sensor group based on a predefined variance or standard deviation.

5. The administration server according to claim 4,
wherein the processing unit determines request intervals for respective sensor groups based on priorities predetermined for the respective sensor groups so that the sensor group having a higher priority has a shorter request interval.

6. The administration server according to claim 5,
wherein the processing unit determines the priorities based on a data change ratio of information acquired from a plurality of sensors of each respective sensor group so that a higher data change ratio corresponds to a higher priority.

7. The administration server according to claim 5,
wherein the processing unit calculates an average value of information acquired from a plurality of sensors of each sensor group, and in a case where the average value is equal to or greater than a predetermined threshold value, the processing unit sets the priority of the sensor group to be high, and determines a request interval for the sensor group to be short.

8. The administration server according to claim 5,
wherein in a case where data of a sensor group in which a data change ratio is equal to or more than a predetermined threshold value is acquired according to a predetermined correlation between predefined clustered sensor groups, the processing unit further acquires data of a sensor group having a high correlation with the sensor group, or determines a priority of a sensor group having a high correlation with a sensor group whose priority is more than a predetermined threshold value, to be high.

9. The administration server according to claim 5,
wherein the apparatus obtains an instantaneous Mahalanobis distance based on time-series data of clustered sensor information to be transmitted, and determines a priority of a sensor group to be high in a case where the Mahalanobis distance exceeds a predetermined threshold value.

10. The administration server according to claim 1,
wherein the action definition file stores the number of sensors, the types of sensors, and the CPU threshold value with respect to the behavior state and radio wave intensity, in advance, and
wherein the processing unit acquires radio wave intensity of communication with the apparatus, refers to the action definition file, and acquires the number of sensors, the types of sensors, and the CPU threshold value according to the behavior state of the apparatus and the radio wave intensity.

11. An administration system comprising:
an apparatus having a plurality of sensors; and
an administration server having an action definition file in which the number of sensors, types of sensors, and a CPU threshold value are stored in advance with respect to a behavior state of the apparatus;
wherein the administration server
acquires a behavior state of the apparatus,
refers to the action definition file, and determines the number and types of a plurality of sensors which acquire data from the apparatus, based on the number of sensors and the types of sensors for the behavior state of the apparatus,
determines a request interval for requesting a data acquisition of the plurality of sensors so that a CPU use ratio of the apparatus does not exceed the CPU threshold value by the number of sensors,
requests the data acquisition of the plurality of sensors to the apparatus in accordance with the request interval, and
wherein the apparatus transmits the data of the plurality of sensors to the administration server in response to the request from the server.

12. The administration system according to claim 11,
wherein the administration server measures an amount of information transmitted from the apparatus as a throughput, and transmits a control command for aggregating transmitted packets to the apparatus in a case where the measured throughput is equal to or more than a predetermined threshold value, and
wherein the apparatus aggregates clustered sensor information to be transmitted, and transmits the sensor information to the administration server.

13. The administration system according to claim 12,
wherein, if the control command is received, the apparatus aggregates information of a plurality of sensors of a sensor group having low priority and transmits the aggregated information to the administration server.

14. The administration system according to claim 12,
wherein the apparatus aggregates information of a plurality of sensors of a sensor group in which a data change ratio is more than a predetermined threshold value among sensor information to be transmitted for each sensor group, and transmits the aggregated information to the administration server.

15. An administration method by an administration server, the administration server comprising:
an action definition file in which the number of sensors, types of sensors, and a CPU threshold value are stored in advance with respect to a behavior state of an apparatus having a plurality of sensors; and
a processing unit,
wherein the processing unit
acquires a behavior state of the apparatus,
refers to the action definition file, and determines the number and types of a plurality of sensors which acquire data from the apparatus, based on the number of sensors and the types of sensors for the behavior state of the apparatus, and
determines a request interval for requesting a data acquisition of the plurality of sensors so that a CPU use ratio of the apparatus does not exceed the CPU threshold value by the number of sensors.
